(19) United States
(12) Patent Application Publication
(10) Pub. No.: US 2018/0142175 A1
(43) Pub. Date: May 24, 2018

(54) FOAM CONTROL OF GAS SWEETENING PROCESSES

(71) Applicant: Dow Global Technologies LLC, Midland, MI (US)

(72) Inventor: Runyu Tan, Richwood, TX (US)

(21) Appl. No.: 15/568,184

(22) PCT Filed: May 11, 2016
(86) PCT No.: PCT/US2016/031765

§ 371 Date: Oct. 20, 2017

Related U.S. Application Data
(60) Provisional application No. 62/162,146, filed on May 15, 2015.

(51) Int. Cl. C10L 3/10; B01D 53/14; B01D 53/96; C08L 71/02

(52) U.S. Cl. CPC C10L 3/103; B01D 2257/80; C10L 3/106; B01D 53/1468; B01D 53/1475; B01D 53/1481; B01D 53/96; C08L 71/02; C10L 2290/541; B01D 2252/2021; B01D 2252/2025; B01D 2252/2026; B01D 2252/20484; B01D 2252/20489; B01D 2252/20468; B01D 2252/608; B01D 2257/302; B01D 2257/304; B01D 2257/306; B01D 2257/308; B01D 2257/408; B01D 2257/504; C10L 3/104

(57) ABSTRACT

There is provided herein a method for processing a gas comprising one or more impurity, the method comprising a) treating the gas with an impurity lean gas treating composition comprising i) a foam control agent comprising a polyalkylene glycol made by the polymerization of one or more alkylene oxide monomer initiated by a polyhydric compound having a functionality equal to or greater than 3 and ii) a gas treating agent and b) forming an impurity loaded gas treating composition. Preferably the gas is refinery gas or natural gas.

### FIELD OF THE INVENTION

The invention relates to low-foaming gas processing compositions of particular use in gas sweetening processes, particularly refinery and natural gas sweetening processes.

### BACKGROUND OF THE INVENTION

In acid gas sweetening, gases such as carbon dioxide and hydrogen sulfide are removed via scrubbing with chemical solvents such as an aqueous amine solution, or physical solvents such as mixtures of dialkylethers of polyethylene glycols. The amine forms an adduct with the base-reactive impurity, thereby removing the impurity from the gas. See, for example, U.S. Pat. Nos. 6,929,680 and 5,314,672. The physical solvents remove the impurity from the gas by solubility differences. See, for example, U.S. Pat. No. 7,637,984 B2.

Problematic foam can occur during both the scrubbing or regeneration steps in this process. Undesirable foam can lead to a number of operating difficulties and significant economic consequences. The need for foam control or elimination in acid gas sweetening of natural gas is well-appreciated in the art.

There has been much focus on anti-foaming technologies in the areas of detergents, polymer processing, well treating, and waste streams. See, for example, U.S. Pat. Nos. 3,846,329; 6,156,808; 6,369,022; 6,512,015; and 6,521,587. These antifoaming technologies are generally not well suited for the reduction of foam in gas sweetening processes.

US Publication 20080121104 discloses an antifoaming formulation comprising a silicone copolymer for a gas sweetening process. However, silicon based foam control agents can potentially deactivate catalysts used in various refinery processes.

There still remains a need for gas sweetening compositions with more effective foam controlling properties. The present invention is directed to this need.

### SUMMARY OF THE INVENTION

The present invention is a method for processing a gas, preferably natural gas, comprising one or more impurity, preferably the one or more impurity is water, carbon dioxide, hydrogen sulfide, sulfur dioxide, carbon disulfide, hydrogen cyanide, carbonyl sulfide, or mercaptans, the method comprising a) treating the gas with an impurity lean gas treating composition comprising i) a foam control agent comprising a polyalkylene glycol made by the polymerization of one or more alkylene oxide monomer initiated by a polyhydric compound having a functionality equal to or greater than 3 and ii) a gas treating agent and b) forming an impurity loaded gas treating composition.

In one embodiment of the method of the present invention disclosed herein above the one or more monomer is ethylene oxide, propylene oxide, or combinations thereof, preferably the polyalkylene oxide is a copolymer of ethylene oxide and propylene oxide in which units derived from ethylene oxide comprise from 5 to 95 weight percent.

In one embodiment of the method of the present invention disclosed herein above the initiator is glycerin, trimethylolpropane, sorbitol, pentaerythritol, sucrose, or combinations thereof.

In one embodiment of the method of the present invention disclosed herein above the gas treating agent is one or more of an amino-containing compound or polymer, preferably monoethanolamine, diethanolamine, N,N-diethylethanolamine, monoisopropanolamine, diisopropanolamine, tri-isopropanolamine, triethanolamine, N-methyldiethanolamine, N,N-dimethylethanolamine, monomethylethanolamine, (2-(2-aminoethoxy)ethanol, 3-(dimethylamino)-1,2-propanediol, 3-(diethylamino)-1,2-propanediol, 2-amino-2-methyl-1-propanol, 2-dimethylamino-2-methyl-1-propanol, 2-amino-2-hydroxymethyl-1,3-propanediol, 2-dimethylamino-2-hydroxymethyl-1,3-propanediol, piperazine, 1-(2-hydroxyethyl)piperazine, 1,4-bis(2-hydroxylethyl)piperazine, methylamine, ethylamine, n-propylamine, isopropyl amine, n-butylamine, isobutylamine, sec-butylamine, and t-butylamine, dimethylamine, diethylamine, methylethylamine, isopropylmethylamine, isopropylethylamine, diisopropylamine, and isobutylmethylamine, trimethylamine, triethylamine, tri(n-propyl)amine, ethyldimethylamine, n-propyldimethylamine, isobutyldimethylamine, diisopropylmethylamine, or scavengers such as triazine, iron chelates, or physical solvents including cyclotetramethylene sulfone (sulfolane) and its derivatives, aliphatic acid amides, n-methylpyrrolidone (NMP), N-alkylated pyrrolidones and corresponding piperidone, methanol, methoxy triethylene glycol, mixtures of dialkylethers of polyethylene glycols (such as SELEXOL™ Solvents for Gas Treating available from The Dow Chemical Company), or combinations thereof.

In one embodiment of the method of the present invention disclosed herein above further comprising the step of c) regenerating the loaded gas treating composition to form an impurity lean gas treating composition by a temperature swing absorption process, a pressure swing absorption process, or combinations thereof.

### DETAILED DESCRIPTION OF THE INVENTION

The present invention is a low-foaming gas treating composition and use thereof in a gas sweetening process, preferably a natural gas sweetening process. Said low-foaming gas treating composition comprises a foam control agent, preferably a polyalkylene glycol (PAG) and an aqueous gas treating agent, preferably a chemical solvent, such as an amino-containing compound; a physical solvent; a scavenger; or combinations thereof.

Raw natural gas comes from three types of wells: oil wells, gas wells, and condensate wells. Natural gas that comes from oil wells is typically termed “associated gas”. This gas can exist separate from oil in the formation (free gas), or dissolved in the crude oil (dissolved gas). Natural gas from gas and condensate wells, in which there is little or no crude oil, is termed “non-associated gas”. Gas wells typically produce raw natural gas by itself, while condensate wells produce free natural gas along with a semi-liquid hydrocarbon condensate. Whatever the source of the natural gas, once separated from crude oil (if present) it commonly exists as methane in mixtures with other hydrocarbons; principally ethane, propane, butane, and pentanes and to a lesser extent heavier hydrocarbons.

Natural gas, raw or treated, often contains impurities. Removal of one or more impurities is referred to a “gas sweetening”. Said impurities may include water or acid gases, for example carbon dioxide (CO₂), hydrogen sulfide (H₂5), sulfur dioxide (SO₂), carbon disulfide (CS₂), hydrogen cyanide (HCN), carbonyl sulfide (COS), or mercaptans as impurities. The term “natural gas feedstream” as used in the method of the present invention includes any natural gas source, raw or raw natural gas that has been treated one or more times to remove water and/or other impurities.

Refinery gas is a mixture of gases generated during refinery processes which are used to process crude oil into various petroleum products. The composition of refinery gas varies, depending on the composition of the crude it originates from and the processes it has been subjected to, some examples of refinery gases are syn gas, gas from acid gas enrichment, tail gas, and the like.

Defoamers and antifoams are additives that are used to reduce or eliminate problematic foam. An “antifoam” refers to a long-acting agent which prevents foam formation. A “defoamer” is a material that yields rapid knock-down of existing foam. Herein, the term “foam control agent” is used to refer to additives that eliminate and/or control foam since many applications and processes require both foam prevention and reduction or elimination.

Suitable foam control agents used in the practice of this invention are polyalkylene glycols (PAG). PAGs are made by the polymerization of an alkylene oxide monomer or a mixture of alkylene oxide monomers initiated by a polyhydric compound, and promoted by a base catalyst, e.g., potassium hydroxide, under reactive conditions known in the art with specific compositions based on modifications of known compounds (see, for example, “Alkylene Oxides and Their Polymers”, Surfactant Science Series, Vol. 35). Upon the completion of the polymerization, the reaction mixture is vented and then neutralized by the addition of one or more acids, e.g., acetic acid. Optionally, the salts resulting from the neutralization, e.g., potassium acetate salts, can be removed by any known means, e.g., filtration. The neutralized polyalkylene glycol product has a pH value of 4.0 to 8.5.

In a preferred embodiment the PAG is a branched PAG, in other words, it is made from an initiator that is a polyhydric compound with a functionality of equal to or greater than 3, or equal to or greater than 4, or equal to or greater than 5, or equal to or greater than 6. Examples of such initiators include but are not limited to glycerin, trimethylolpropane, sorbitol, pentaerythritol, sucrose, and any mixture of the same.

The PAG of this invention can be prepared by a variety of methods known in the art. In one embodiment, the PAG is prepared by base-catalyzed alkoxylation. The base is typically at least one of an alkali or alkaline earth metal hydroxide or carbonate, aliphatic amine, aromatic amine, or a heterocyclic amine. In one embodiment, sodium or potassium hydroxide is the base catalyst. In one embodiment the PAG is neutralized with a carboxylic acid, e.g., acetic acid. In one embodiment the soluble acid salts, e.g., potassium acetate salts, are left in the PAG while in another embodiment, the salt is filtered out or otherwise removed from the PAG. In one embodiment the PAG is prepared by acid-catalyzed alkoxylation.

The alkylene oxide used as the monomer in the polymerization is a C₂ to C₈ oxide, such as ethylene oxide, propylene oxide, butylene oxide, hexene oxide, or octene oxide. In one embodiment, the alkylene oxide is ethylene oxide (EO), propylene oxide (PO), or mixtures thereof.

In one embodiment of this invention the polyalkylene oxide is polyethylene oxide, or a polypropylene oxide, or a water soluble copolymer of ethylene oxide and propylene oxide, or a mono-methyl, -ethyl, -propyl, or -butyl ether of one of them, initiated by glycerol, sorbitol or sucrose.

In one embodiment the polyalkylene oxide is a copolymer of EO and PO in which units derived from EO comprise from 5 to 95 weight percent (wt %), typically from 10 to 35 wt %, more typically from 15 to 30 wt %, and more typically from 19 to 27 wt %. In one embodiment, the polyalkylene glycol has a molecular weight (weight average, Mw) of 10 to 10,000 grams per mole (g/mol), more typically 1,000 to 6,000 g/mol.

In one embodiment, for a copolymer of EO and PO the PO polymerization occurs first and then EO polymerization is used to cap the glycerol initiated polypropylene glycol.

The PAG of this invention is used as a foam control agent in known ways and in known amounts. It is used in a foam controlling amount, i.e., in an amount sufficient to control the level of foam in gas treating agent. Typically it is used in an amount of 1 to 2,000 parts per million (ppm), more typically 5 to 500 ppm based on the gas treating agent. The PAG can be added continuously or intermittently to the aqueous gas scrubbing solution.

The PAG of this invention can be added to the gas treating agent neat, i.e., alone, or in combination with one or more other materials such as, without limitation, solvents, stabilizers, corrosion inhibitors, antioxidants, fillers and other foam control agents. Representative of these other materials are PAG with a functionality of 2 or less, silicones, silica, hydrocarbon oil, reaction product of polyamine and alkynyl diol, N,N-diethylhydroxylamine, carbohydrazide, hydroquinone, mono alkyl quaternary ammonium salt, alkyl diol, vegetable oil, and the like.

In one embodiment of the present invention gas-treating agent can be any material used in the treatment and/or processing of gases, specifically any material capable of reacting with a base-reactive impurity in a gas or dissolving at least part of the impurity.

In one embodiment of the present invention the gas treating agent is a water-soluble or water-dispersible gas-processing component (i.e., the gas sweetening agent), and more specifically, a gas sweetening amine.

In a more specific embodiment the gas treating agent includes any one or combination of amino-containing compounds or polymers capable of reacting with a base-reactive impurity in a gas while in the present composition. Preferably, the amines are at least partially soluble in aqueous solution. If necessary, amines of low aqueous solubility can be emulsified using one or more suitable surfactants.

In one embodiment of the present invention the gas treating agent is a water-soluble or water-dispersible gas-processing component (i.e., the gas sweetening agent), and more specifically, a physical solvent such as dialkylethers of polyethylene glycols.

Suitable gas treating agents include, but are not limited to, alkanolamines, alkylamines, and combinations thereof. Some specific examples include, monoethanolamine (MEA), diethanolamine (DEA), N,N-diethylethanolamine (DEEA), monoisopropanolamine (MIPA), diisopropanolamine (DIPA), tri-isopropanolamine (TIPA), triethanolamine (TEA), N-methyldiethanolamine (MDEA), N,N-dimethylethanolamine (DMEA), monomethylethanolamine, (2-(2-aminoethoxy)ethanol, 3-(dimethylamino)-1,2-propanediol (DMAPD), 3-(diethylamino)-1,2-propanediol, 2-amino-2-methyl-1-propanol (AMP), 2-dimethylamino-2-methyl-1-propanol (DMAMP), 1-(2-hydroxyethyl)piperazine, 1,4-bis(2-hydroxylethyl)piperazine, 2-amino-2-hydroxymethyl-1,3-propanediol, 2-dimethylamino-2-hydroxymethyl-1,3-propanediol, and combinations thereof.

Some examples of suitable gas treating agents which are alkylamines include monoalkylamines, dialkylamines, trialkylamines, and combinations thereof. Some specific non-limiting examples of monoalkylamines include methylamine, ethylamine, n-propylamine, isopropyl amine, n-butylamine, isobutylamine, sec-butylamine, and t-butylamine some specific non-limiting examples of dialkylamines include dimethylamine, diethylamine, methylethylamine, isopropylmethylamine, isopropylethylamine, diisopropylamine, and isobutylmethylamine some specific non-limiting examples of trialkylamines include trimethylamine, triethylamine, tri(n-propyl)amine, ethyldimethylamine, n-propyldimethylamine, isobutyldimethylamine, and diisopropylmethylamine.

The gas-treating agent can also include polyamines, i.e., diamines, triamines, tetramines, and higher amines some specific non-limiting examples of such polyamines include ethylenediamine, diethylenetriamine, triethylenetetramine, tetraethylenepentamine, and polyamine polymers.

The gas-treating agent can also include amino-containing ring compounds. Some specific non-limiting specific examples of such compounds include the piperidines, piperazines, pyridines, pyrazines, pyrroles, pyrrolidines, pyrrolidinones, morpholines, anilines, aminophenols, anisidines, triazines, and the like.

The gas-treating agent can also include imines such as triazine formed by a condensation reaction between an amine and a carbonyl-containing compound such as formaldehyde.

The gas-treating agent can also include metal chelate solutions such as iron chelate (for example SULFEROX™ Process Technologies from The Dow Chemical Company).

The gas-treating agent can be physical solvents such that the impurities dissolve at least partially in the solvents. Some specific non-limiting examples include cyclotetramethylene sulfone (sulfolane) and its derivatives, aliphatic acid amides, n-methylpyrrolidone (NMP), N-alkylated pyrrolidones and corresponding piperidone, methanol, methoxy triethylene glycol, mixtures of dialkylethers of polyethylene glycols, or combinations thereof.

The gas-treating agent can be a mixture of both chemical solvents and physical solvents

The gas-treating agent can be non-selective, and hence, reactive to any number of base-reactive impurities in a gas. Alternatively, the gas-treating agent can be selective, i.e., more reactive to one or a particular group of base-reactive impurities, or perhaps unreactive to one or more base-reactive impurities while reactive to one or more other base-reactive impurities.

In one embodiment of the present invention, the method for processing a gas can comprise lowering or substantially removing an amount of at least one base-reactive impurity from a gas by treating the gas with any one or more of an impurity lean gas treating compositions described herein. The method advantageously processes the gas (removes base-reactive impurities) while effectively removing and/or suppressing the formation of foam in the method while forming an impurity loaded gas treating composition.

The gas to be processed can be any of the commonly known gases, which require removal of base reactive species. In one embodiment, the gas is a tail gas, a syn gas, a gas sent for acid gas enrichment, or a landfill gas. In a specific embodiment, the gas is natural gas, which preferably is substantially composed of methane. The gas can also be any other hydrocarbon gas including ethane, propane, butane, and the like, as well as inert gases, such as nitrogen and the noble gases.

Examples of the base-reactive impurities in the gas are most commonly removed are carbon dioxide, sulfhydryl-containing compounds, and combinations thereof. The sulfhydryl-containing compounds include, most notably, hydrogen sulfide, but can include other mercaptans such as methanethiol.

In the method herein, the gas can be treated by any means known in the art for gas sweetening or gas dehydration. For example, the gas can be treated by spraying or aerosoling the compositions described above in the gas, or bubbling the gas through the gas processing composition, or any combination of said spraying, aerosoling or bubbling. See, for example, “Oilfield Processing of Petroleum: Natural Gas (Oilfield Processing of Petroleum)” by Francis S. Manning, 1991, PennWell Publishing Co., Tulsa, Okla.

In a more specific embodiment, the low-foaming gas treating composition, e.g., the loaded gas treating composition, is regenerated by a gas desorption process to provide lean gas treating composition. The term regenerated refers to a process, wherein at least a portion of the solution of the loaded composition herein comprising any reactive impurities passes through the desorber where the acid gases are removed and impurity lean gas treating composition can be recaptured for further absorption. In the gas desorption process, elevated temperature (such as a temperature swing absorption (TSA) process), reduced pressure (such as a pressure swing absorption (PSA) process), or combinations thereof are used to effect the desorption of the adducted base-reactive species, thereby reclaiming at least a portion, and more specifically at least a substantial portion, of the gas treating solution.

In one embodiment of the present invention the gas treating agent is present in the composition in a gas-processing effective amount. A gas-processing effective amount is an amount of gas treating agent that can cause at least some sweetening of a gas that is being removed in a gas-sweetening process. In a more specific embodiment of the present invention a gas-processing effective amount is an amount that will cause equal to or greater than a 1 percent reduction in the amount of base-reactive impurities in the gas, more specifically, equal to or greater than a 20 percent reduction in the amount of base-reactive impurities in the gas, even more specifically, equal to or greater than a 50 percent reduction in the amount of base-reactive impurities in the gas and more specifically equal to or greater than a 80 percent reduction in the amount of base-reactive impurities in the gas, most specifically equal to or greater than a 99 percent reduction in the amount of base-reactive impurities in the gas said percents being based on the total amount of base-reactive impurities in the gas being treated, said percent reductions also defining the “substantial” removal of a base-reactive impurity in the gas.

In a more specific embodiment, in the method for processing a gas of the present invention, treating the gas with the composition described herein, is accomplished by mixing an amount of the PGA foam control agent described herein above with a gas treatment agent, preferably an aqueous solution containing a gas treatment agent as described herein. In an even more specific embodiment of the present invention, an amount of the PGA foam control agent is mixed with an aqueous amine gas sweetening solution so as to provide a mixture having the PGA foam control agent in a minimum amount equal to or greater than 1 ppm, equal to or greater than 5 ppm, and equal to or greater than 10 ppm and equal to or less than 2,000 ppm, equal to or less than 1000 ppm, equal to or less than 500 ppm, and equal to or less than 100 ppm, and all ranges resulting from combination of the minima and maxima given, and all subranges there between, by weight of final mixture. The resulting mixture containing the PGA is then used to treat the gas in a gas sweetening process. In one even more specific embodiment of the present invention the amount of composition herein that can be used in a method for processing a gas can vary greatly depending on the individual gas that is to be treated but can comprise an amount that will result in the above indicated amounts of reduction in base-reactive impurities.

For gas sweetening applications, an aqueous amine solution comprises one or more alkanolamines, alkylamines, or combination thereof, in aqueous solution, specifically, in a minimum amine weight percentage of about 5 weight percent and a maximum amine weight percentage of about 75 weight percent by weight of the aqueous solution. Some more specific non-limiting amine concentrations include 5 to 30 weight percent of monoethanolamine, 5 to 50 weight percent of diethanolamine, 5 to 40 weight percent of MDEA, and up to 65 weight percent of 2-(2-aminoethoxy)ethanol.

Numerous other auxiliary ingredients can be included to the gas processing composition described herein. For example, it is common practice to include one or more components selected from biocides, diluents, thickeners, pH adjusters, buffers, corrosion inhibitors or oxidation inhibitors.

The compositions and methods provided herein can be used in gas sweetening processes.

### Examples

Three foam control agents are evaluated, Comparative Example A is a polypropylene oxide (PO) available as FLUENT-LUB™ 347 Polyglycol from The Dow Chemical Company, Comparative Example B is a linear EO/PO PAG copolymer of 10% EO and PO initiated from mono propylene glycol available as TERGITL™ L-61 from The Dow Chemical Company, and Example 1 is a branched EO/PO PAG copolymer comprising 14% EO and PO initiated from glycerin available as VORANOL™ 4701 from The Dow Chemical Company.

Each foam control agent is diluted with water to form a 1% and a 10% solution. From one or both solutions, 25 mg is added to 50 mL of lean gas treating agent diethanolamine (DEA) or lean gas treating agent N-methyldiethanolamine (MDEA). The mixture is added to a 50 mL graduated cylinder and nitrogen gas is sparged through the solution at 1 L/min for 5 min. The foam height is calculated by subtracting the final volume of the foam by the initial volume of the solution. The results are provided in Table 1.

TABLE 1

Foam Height, mL

| | DEA | MDEA |
|---|---|---|
| Comparative Example A | | |
| 0 ppm | 40 | 200 |
| 5 ppm | 25 | 200 |
| 50 ppm | 25 | 10 |
| Comparative Example B | | |
| 0 ppm | 40 | 200 |
| 5 ppm | 20 | 130 |
| 50 ppm | 15 | 10 |
| Example 1 | | |
| 0 ppm | 40 | 200 |
| 5 ppm | 6 | 10 |
| 50 ppm | 6 | 10 |

As can be seen by the data in Table 1, the branched PGA example of the present invention provides improved foam control versus polypropylene oxide or a linear PGA not an example of the present invention.

What is claimed is:

1. A method for processing a gas comprising one or more impurity, the method comprising
a) treating the gas with an impurity lean gas treating composition comprising
i) a foam control agent comprising a polyalkylene glycol made by the polymerization of one or more alkylene oxide monomer initiated by a polyhydric compound having a functionality equal to or greater than 3 and
ii) a gas treating agent
and
b) forming an impurity loaded gas treating composition.

2. The method of claim 1 wherein the one or more monomer is ethylene oxide, propylene oxide, or combinations thereof.

3. The method of claim 1 wherein the polyalkylene oxide is a copolymer of ethylene oxide and propylene oxide in which units derived from ethylene oxide comprise from 5 to 95 weight percent.

4. The method of claim 1 wherein the polyalkylene oxide is a copolymer of ethylene oxide and propylene oxide in which units derived from ethylene oxide comprise from 10 to 35 weight percent.

5. The method of claim 1 wherein the initiator is glycerin, trimethylolpropane, sorbitol, pentaerythritol, sucrose, or combinations thereof.

6. The method of claim 1 wherein the gas is natural gas, a tail gas, a syn gas, a gas sent for acid gas enrichment, or a landfill gas.

7. The method of claim 1 wherein the one or more impurity is water, carbon dioxide, hydrogen sulfide, sulfur dioxide, carbon disulfide, hydrogen cyanide, carbonyl sulfide, or mercaptans.

8. The method of claim 1 wherein the gas treating agent is a chemical solvent, a physical solvent, or mixtures thereof.

9. The method of claim 1 wherein the gas treating agent is a one or more of an amino-containing compound or polymer.

10. The method of claim 1 wherein the gas treating agent is monoethanolamine, diethanolamine, N,N-diethylethanolamine, monoisopropanolamine, diisopropanolamine, tri-isopropanolamine, triethanolamine, N-methyldiethanolamine, N,N-dimethylethanolamine, monomethylethanolamine, (2-(2-aminoethoxy)ethanol, 3-(dimethylamino)-1,2-propanediol, 3-(diethylamino)-1,2-propanediol, 2-amino-2-methyl-1-propanol, 2-dimethylamino-2-methyl-1-propanol, 2-amino-2-hydroxymethyl-1,3-propanediol, 2-dimethylamino-2-hydroxymethyl-1,3-propanediol, piperazine, 1-(2-hydroxyethyl)piperazine, 1,4-bis(2-hydroxylethyl)piperazine, methylamine, ethylamine, n-propylamine, isopropyl amine, n-butylamine, isobutylamine, sec-butylamine, and t-butylamine, dimethylamine, diethylamine, methylethylamine, isopropylmethylamine, isopropylethylamine, diisopropylamine, and isobutylmethylamine, trimethylamine, triethylamine, tri(n-propyl)amine, ethyldimethylamine, n-propyldimethylamine, isobutyldimethylamine, diisopropylmethylamine, triazine, iron chelates, cyclotetramethylene sulfone and its derivatives, aliphatic acid amides, n-methylpyrrolidone (NMP), N-alkylated pyrrolidones and corresponding piperidone, methanol, methoxy triethylene glycol, mixtures of dialkylethers of polyethylene glycols, or combinations thereof.

11. The method of claim 1 further comprising the step of
c) regenerating the loaded gas treating composition to form an impurity lean gas treating composition by a temperature swing absorption process, a pressure swing absorption process, or combinations thereof.

12. The method of claim 1 wherein the gas treating composition further comprises one or more of a biocide, a diluent, a thickener, a pH adjuster, a buffer, a corrosion inhibitor, or an oxidation inhibitors.
